(19) United States
(12) Patent Application Publication
(10) Pub. No.: US 2026/0133769 A1
(43) Pub. Date: May 14, 2026

(54) CODE GENERATATION SYSTEM USING COMPONENT ECOSYSTEM AND GENERATIVE ARTIFICIAL INTELLIGENCE

(71) Applicant: eBay Inc., San Jose, CA (US)

(72) Inventors: Hari Narayanan RANGARAJAN, San Jose, CA (US); Sahithi MALLAVARAPU, San Jose, CA (US)

(21) Appl. No.: 18/948,007

(22) Filed: Nov. 14, 2024

(51) Int. Cl. G06F 8/35

(52) U.S. Cl. CPC G06F 8/35

(57) ABSTRACT

Some aspects relate to technologies for software development using a component ecosystem with generative artificial intelligence. In accordance with some aspects, natural language text is received for code generation. Based on the natural language text, one or more component specifications are identified, and a prompt is generated from the natural language text and the component specification(s). Each component specification has a corresponding input, a corresponding output, and one or more corresponding properties. Given the prompt, a generative model generates one or more component instances by hydrating one or more properties of the component specification(s). When multiple component instances are generated, the generative model can also determine a control flow logic specifying an order for the component instances, and the generative model can further generate a translation layer between successive component instances.

### BACKGROUND

Software development can be approached in various ways, each offering different levels of complexity and automation. Manual code generation by a developer is the traditional method, where a programmer writes detailed code using languages like Python, Java, or C++ to create customized software solutions, offering full control over functionality. In contrast, no-code/low-code platforms provide visual interfaces that allow users, often with minimal technical knowledge, to build applications through drag-and-drop components or simple configuration, reducing the need for manual coding. A more recent approach leverages generative artificial intelligence (AI), where generative AI models, such as OpenAI Codex and Starcoder, assist in creating code based on natural language descriptions, accelerating development by automatically generating functional code snippets or even entire applications.

### SUMMARY

Some aspects of the present technology relate to, among other things, a software development system that leverages a component ecosystem and generative artificial intelligence for software development. The component ecosystem involves the use of component specifications, which follow a standardized schema comprising an input, an output, and a set of one or more properties that can be hydrated to produce component instances. Given a natural language input, the software development system identifies one or more relevant component specifications. An input (i.e., a prompt) is provided to a generative model based on the natural language input and the identified component specification(s). The generative model hydrates one or more properties of the component specification(s) to provide component instance(s). When multiple component instances are generated, the generative model also determines a control flow logic setting forth an order of execution for the component instances. Additionally, the generative model generates a translation layer between successive component instances to translate the output from one component instance to the input of a subsequent component instance.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram showing an example of a component in accordance with some implementations of the present disclosure;

FIG. 3 is a block diagram showing an example of components connected with translation layers in accordance with some implementations of the present disclosure;

FIGS. 4A-4C provide examples of a component specification, JAVA interface code for the component specification, and a component instance generated using the component specification in accordance with some implementations of the present disclosure;

FIG. 5 is an example of a prompt that can be generated and provided to a generative model to generate a component instance in accordance with some implementations of the present disclosure;

FIG. 6 provides examples of prompts that can be used to generate translation layers in accordance with some implementations of the present disclosure;

FIGS. 7A and 7B are example user interfaces illustrating a natural language input and an output comprising a component instance generated using the natural language input in accordance with some implementations of the present disclosure;

FIGS. 8A-8C are example user interfaces illustrating generation of multiple component instances with translation layers based on a natural language input in accordance with some implementations of the present disclosure;

FIG. 9 is block diagram illustrating an example process for code development in accordance with some implementations of the present disclosure;

FIG. 10 is block diagram illustrating another example process for code development in accordance with some implementations of the present disclosure;

FIG. 11 is a flow diagram showing a method for instantiating a component instance using a component ecosystem and generative AI in accordance with some implementations of the present disclosure;

FIG. 12 is a flow diagram showing a method for generating code with multiple components using a component ecosystem and generative AI in accordance with some implementations of the present disclosure; and

FIG. 13 is a block diagram of an exemplary computing environment suitable for use in implementations of the present disclosure.

### DETAILED DESCRIPTION

### Overview

There are a number of drawbacks to existing software development approaches. For instance, manual code generation, while offering complete control and flexibility, has several shortcomings. It can be time-consuming and prone to human error, leading to bugs, inefficiencies, and inconsistencies in the code. Writing complex systems from scratch requires significant expertise and effort, often resulting in slower development cycles and higher costs. Additionally, maintaining and updating manually written code can become cumbersome, especially in large codebases, as changes need to be carefully managed to avoid introducing new issues. The lack of automation also limits scalability and may hinder rapid innovation in fast-paced environments.

No-code/low-code development can be seen as part of a broader trend towards democratizing application development, making it more accessible to a wider range of people, including those with limited coding expertise. No-code/low-code development platforms offer a simplified environment for creating applications, but they come with several drawbacks, notably, vendor lock-in, limited customization and flexibility, overhead with complex logic, limited integration capabilities, learning curve, and dependency on platform updates. While no-code/low-code platforms can significantly speed up the development process and reduce the need for specialized coding knowledge, they may not be suitable for all types of projects, especially those requiring complex, highly customized, or unique solutions.

With the more recent advent of generative AI (artificial intelligence) and coder LLMs (large language models), a current trend is to generate “auto-complete” style code generation for various developer tasks. While efficient and time-saving, generative AI code development has several shortcomings. For instance, this approach is often limited to generating simple code snippets to solve known existing problems. AI-generated code can lack the deep contextual understanding needed for complex or domain-specific problems, leading to incorrect or suboptimal solutions. It may also introduce subtle bugs or security vulnerabilities, especially when handling edge cases or nuanced requirements. The generative AI model could also generate code that works but is difficult to read, maintain, or modify due to lack of comments or clear structure. Additionally, AI models rely on the quality of their training data, which can result in outdated or biased code suggestions if the data is incomplete or flawed.

While it is possible to include very specific instructions through in-context examples of past code in prompts given to generative AI models, it typically requires multiple passes through carefully constructed prompts to generate code that satisfactorily aligns with the developer's intent. Studies have shown that in-context learning can be unstable and very sensitive to the demonstrations included in the prompt. Also, this creates the overhead for developers to pick up the skill of prompt engineering and understand its nuances and limitations. The process is also time consuming due to the multiple back and forth in iterative prompting, which is interventional in nature.

Moreover, the amount of back and forth required between the developer and the generative AI model to arrive at acceptable code often results in the consumption of an unnecessary quantity of computing resources (e.g., I/O costs, network bandwidth usage, throughput, memory consumption, CPU/GPU usage, etc.). For instance, a developer may submit an initial prompt, causing the generative AI model to generate code, which is presented to the developer. The developer reviews the code from the generative AI model and issues another prompt to refine the code, causing the generative AI model to generate a new output. The back and forth process of issuing a prompt and generating code by the generative AI model continues until the developer decides the generated code is sufficient or otherwise decides to manually edit the code. Given the unstructured nature of this process, the number of times this back and forth occurs can be extensive.

Each iteration of this conventional use of generative AI involves consumption of computer resources (e.g., bandwidth, memory, CPU/GPU usage), as well as puts wear and tear on physical computer components. For instance, repetitive prompts adversely affect computer network communications, increasing network bandwidth usage and latency. Additionally, the repetitive inputs from the developer and code generation by the generative AI model increase memory usage, CPU/GPU usage, and storage device I/O (e.g., excess physical read/write head movements on non-volatile disk) because each time a developer inputs another prompt, the computing system often has to reach out to the storage device to perform a read or write operation (which is time consuming, error prone, and can eventually wear on components, such as a read/write head) and consume processor and memory resources in executing the generative AI to generate code.

Aspects of the technology described herein improve the functioning of the computer itself in light of these shortcomings in current software development approaches by a solution that utilizes an open-model of component architecture in conjunction with generative AI for software development.

The component ecosystem used by the technology described herein allows any complex function to be captured in a simple I/O transformation interface. Each component is defined using a component specification that employs a schema identifying an input, an output, and one or more properties that can be hydrated to generate component instances. In some aspects, a component specification can also include metadata providing a description of the component. Component specifications can be manually created by developers, generated using generative AI tools, and/or derived by normalizing legacy code, and the component specifications can be stored in a repository.

Given a natural language input, the system identifies relevant component specifications from the repository and causes a generative model to instantiate component instances by hydrating properties of the identified component specifications based on the natural language input. The natural language input can comprise, for instance, text entered by a developer describing desired functionality and/or components. Based on this natural language input, the system identifies relevant component specifications, for instance, using text-based methods (e.g., keyword matching or TF-IDF), embedding-based approaches, rule-based systems, ontology-based approaches, case-based reasoning, and machine learning models trained to map natural language input to component specifications.

Once relevant component specifications are identified for a natural language input, a generative model generates code using the natural language input and the identified component specifications. In some cases, a single component specification is identified for a natural language input and hydrated to provide a component instance. In other cases, multiple component specifications are identified for a natural language input and hydrated to provide multiple component instances. In such cases, the generative model can also provide a control flow logic specifying an order of execution of the component instances. Additionally, the generative model can generate translation layers to connect successive component instances by translating the output from one component instance to an input for a subsequent component instance in the execution order.

Aspects of the technology described herein provide a number of improvements over existing software development. For instance, the technology described herein provides a comprehensive approach to the generation of complex software systems with interconnected components, all driven by natural language inputs. In some cases, this approach allows for code generation that requires no further editing or only minimal editing, thereby eliminating or at least reducing the need for extensive back and forth editing of code. By leveraging standardized code via components and code normalization, code can be generated with fewer back and forth iterations relative to conventional approaches using generative AI. Accordingly, aspects of the technology described herein provide for reduced computer resource consumption (e.g., bandwidth, memory, CPU/GPU usage) when compared to conventional LLM-based code generation.

The technology described herein offers several technical advantages over conventional software development approaches:
Manual Code Drafting: Traditional manual coding is time-consuming and prone to human error. The technology described herein standardizes code via components and normalizes code, which reduces the likelihood of bugs and inconsistencies. The AI-assisted coding and initialization further streamline the development process, reducing the learning curve and allowing developers to focus on higher-level design and logic rather than low-level coding details.
No-Code/Low-Code Approaches: While no-code/low-code platforms democratize software development, they often suffer from limited customization and flexibility, vendor lock-in, and overhead with complex logic. The technology described herein provides a declarative specification of applications with pluggable and connectable atomic units, offering greater customizability and flexibility. It also supports open modification and easy framework upgrades, making it agnostic to underlying platforms and infrastructure, thus avoiding vendor lock-in.
AI Approaches: Current AI code generation can lack the deep contextual understanding needed for complex or domain-specific problems, leading to suboptimal solutions. The technology described herein uses context to generate AI code and introduces new concepts of code/component normalization, allowing for legacy code base migration and ensuring that generated code is both functional and maintainable. The recursive composition and workflow orchestration simplify maintenance and ensure that the generated code is robust and scalable.

### Example System for Code Generation Using Component Ecosystem and Generative AI

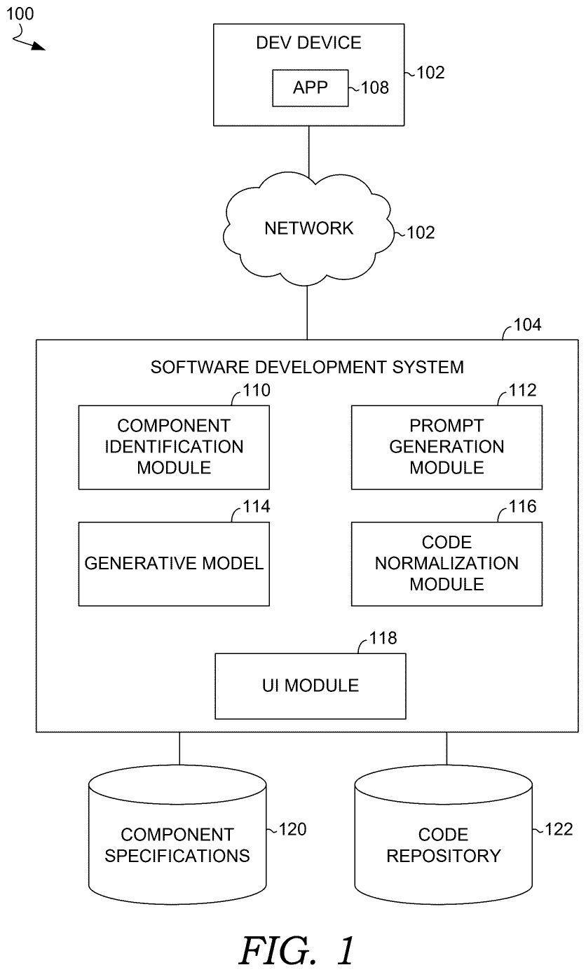

With reference now to the drawings, FIG. 1 is a block diagram illustrating an exemplary system 100 for code generation using a component ecosystem and generative artificial intelligence in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

The system 100 is an example of a suitable architecture for implementing certain aspects of the present disclosure. Among other components not shown, the system 100 includes a developer device 102 and a software development system 104. Each of the developer device 102 and the software development system 104 shown in FIG. 1 can comprise one or more computer devices, such as the computing device 1300 of FIG. 13, discussed below. As shown in FIG. 1, the developer device 102 and the software development system 104 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of developer devices and servers can be employed within the system 100 within the scope of the present technology. Each can comprise a single device or multiple devices cooperating in a distributed environment. For instance, the software development system 104 could be provided by multiple server devices collectively providing the functionality of the software development system 104 as described herein. Additionally, other components not shown can also be included within the network environment.

The developer device 102 can be a client device on the client-side of operating environment 100, while the software development system 104 can be on the server-side of operating environment 100. The software development system 104 can comprise server-side software designed to work in conjunction with client-side software on the developer device 102 so as to implement any combination of the features and functionalities discussed in the present disclosure. For instance, the developer device 102 can include an application 108 for interacting with the software development system 104. The application 108 can be, for instance, a web browser or a dedicated application for providing functions, such as those described herein. This division of operating environment 100 is provided to illustrate one example of a suitable environment, and there is no requirement for each implementation that any combination of the developer device 102 and the software development system 104 remain as separate entities. While the operating environment 100 illustrates a configuration in a networked environment with a separate developer device and software development system, it should be understood that other configurations can be employed in which components are combined. For instance, in some configurations, a developer device can provide some or all capabilities described in conjunction with the software development system.

The developer device 102 can comprise any type of computing device capable of use by a user. For example, in one aspect, the developer device can be the type of computing device 1300 described in relation to FIG. 13 herein. By way of example and not limitation, the developer device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where notifications can be presented. A user, such as a software developer, can be associated with the developer device 102 and can interact with the software development system 104 via the developer device 102.

The software development system 104 provides a platform for developing, testing, and/or deploying software code using a combination of a component ecosystem and generative AI. As shown in FIG. 1, the software development system 104 includes a component identification module 110, a prompt generation module 112, a generative model 114, a code normalization module 116, and a user interface module 118. The modules of the software development system 104 can be in addition to other modules that provide further additional functions beyond the features described herein. The software development system 104 can be implemented using one or more server devices, one or more platforms with corresponding application programming interfaces, cloud infrastructure, and the like. While the software development system 104 is shown separate from the developer device 102 in the configuration of FIG. 1, it should be understood that in other configurations, some or all of the functions of the software development system 104 can be provided on the developer device 102.

In one aspect, the functions performed by modules of the software development system 104 are associated with one or more applications, services, or routines. In particular, such applications, services, or routines can operate on one or more developer devices, servers, can be distributed across one or more developer devices and servers, or be implemented in the cloud. Moreover, in some aspects, these modules of the software development system 104 can be distributed across a network, including one or more servers and client devices, in the cloud, and/or can reside on a developer device. Moreover, these modules, functions performed by these modules, or services carried out by these modules can be implemented at appropriate abstraction layer(s) such as the operating system layer, application layer, hardware layer, etc., of the computing system(s). Alternatively, or in addition, the functionality of these modules and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific modules shown in example system 100, it is contemplated that in some aspects, functionality of these modules can be shared or distributed across other modules.

The software development system 104 provides a generic open-model of component architecture that allows any complex specification to be captured in a simple I/O transformation interface. Each component is defined using a component specification, and the component specifications are stored in a component specification datastore 120. A component specification for a component follows a schema that sets forth the input and output of the component and any properties that can be hydrated to generate a component instance of the component. In some aspects, a component specification can also include metadata, such as a textual description of the component, which allows for an understanding of the capabilities of the component and can be used to help facilitate identification of appropriate component specifications for software development purposes.

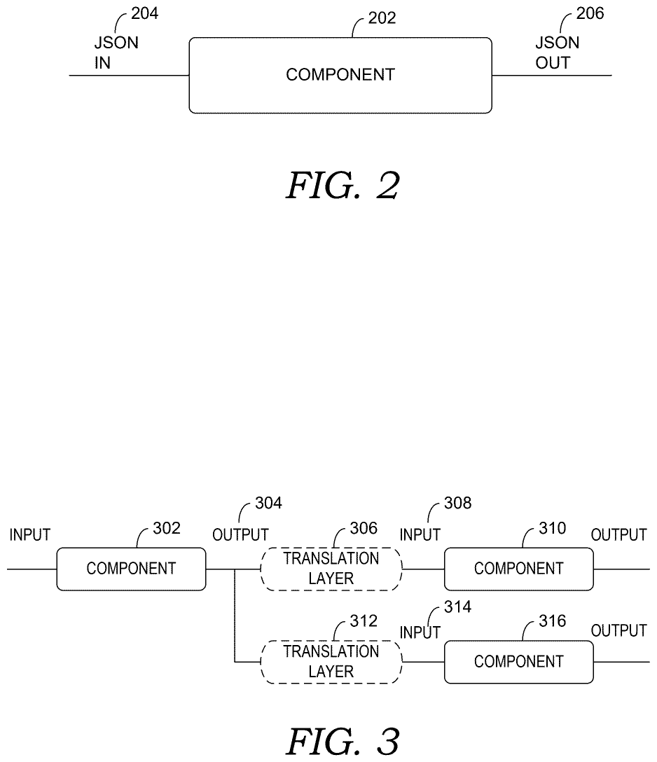

By way of illustration, FIG. 2 provides a block diagram showing a component 202, which is an atomic entity capturing a functionality that processes an input 204 in a coded format, such as JSON (JavaScript Object Notation), and generates an output 206 in a coded format (e.g., JSON). The input and output are schematically specified for each component in its component specification.

Outputs from components can be connected to inputs of subsequent components using translation layers. For instance, a JOLT (JSON-to-JSON transformation) translation layer can be applied for JSON to JSON mappings and conversions. This fundamental structure can be recursively repeated to create any complex flow mapping. By way of example to illustrate, FIG. 3 shows an example control flow with a translation layer 306 that connects the output 304 from the component 302 to the input 308 for the component 310 and a translation layer 312 that connects the output 304 from the component 302 to the input 314 for the component 316.

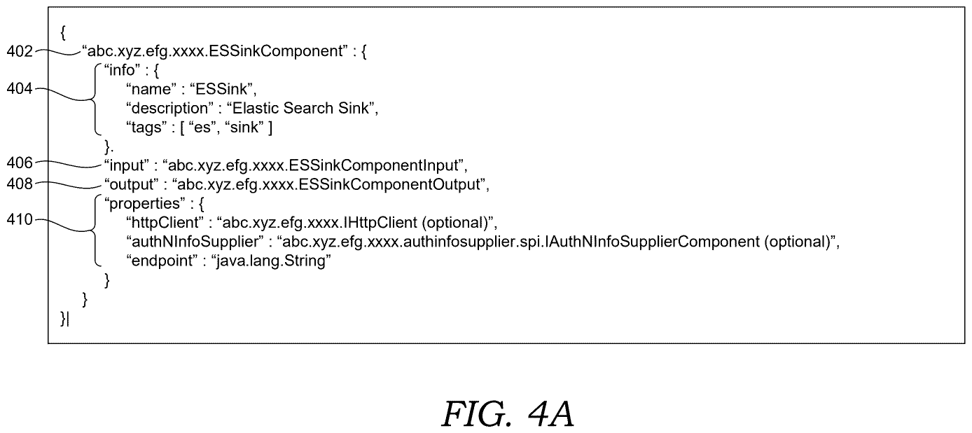

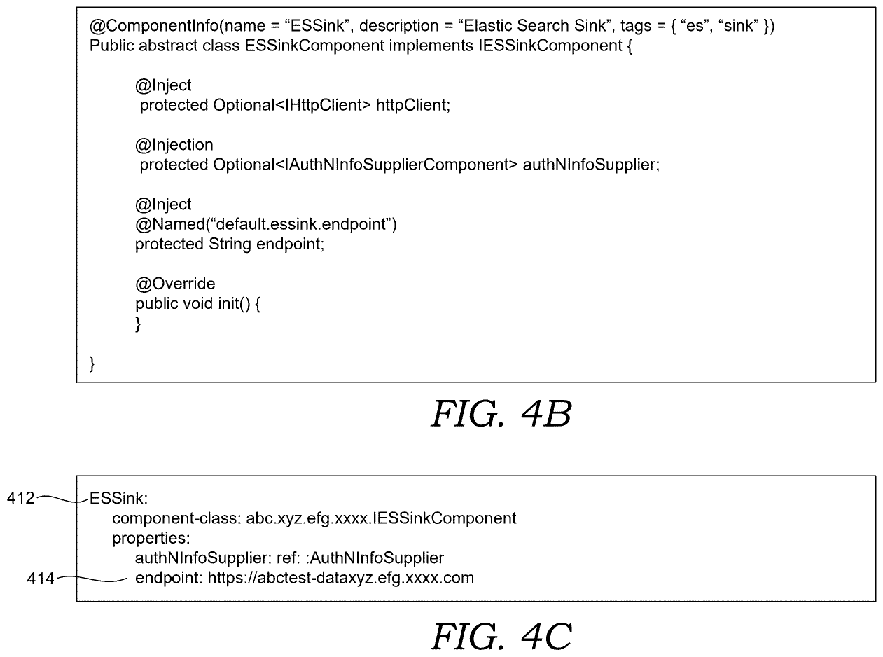

FIG. 4A provides an example of a component specification for an Elastic search component to demonstrate the schema used by components in some aspects of the technology described herein. This example uses a standard schema/template of [component metadata, input, output, properties]. In particular, as shown in FIG. 4A, the component specification includes a component title 402 and metadata 404 providing information describing the component. The component specification also specifies an input 406 and an output 408 for the component. The component specification further includes properties 410, each of which can be hydrated to provide component instances.

FIG. 4B provides an example of JAVA interface code corresponding to the component specification shown in FIG. 4A. FIG. 4C provides an example of an Elastic search component instance in YAML (yet another markup language or YAML ain't markup language) generated using the component specification. As shown in FIG. 4C, the “authNInfoSupplier” property 412 and the “endpoint” property 414 have been hydrated with data to provide the component instance. While FIGS. 4A-4C are provided as examples to illustrate aspects of this technology, it should be understood that the technology described here is not tied to any specific programming language and similar implementations are possible in other languages.

Component specifications can be created in any of a number of different manners. For instance, component specifications can be created entirely manually by developers or can be created with the use of generative AI or other software coding tools. In some cases, component specifications can be created from legacy code by normalizing the legacy code, which will be described in further detail below. Any combination of these methods can be used to generate component specifications that are stored in the component specification datastore 120. While a single component specification datastore 120 is shown in FIG. 1, in operation, one or more data structures can be used to store component specifications and facilitate identification and retrieval of relevant component specifications for software development.

The software development system 104 uses the component specifications in the component specification datastore 120 in conjunction with generative AI to generate software code based on developer input. A software developer can employ a developer device, such as the developer device 102, to interact with the software development system 104 through an interface that allows the developer to provide input for software generation using the component specifications and generative AI. The software development system 104 leverages natural language processing (NLP) and similar techniques to facilitate seamless interaction between developers and the software development system 104. The software development system 104 understands and interprets developers'instructions in natural language text, enabling intuitive code generation and refinement through back-and-forth dialogue. The software development system 104 can maintain contextual awareness, ensuring accurate and relevant responses to developer input. The software development system 104 can also detect issues, such as when the developer hasn't specified information for hydrating properties of a component specification, and provide responses requesting additional information or offering suggestions. In this way, the software development system 104 can serve as a chatbot that simulates human conversation through text or voice interactions by using NLP and machine learning to understand and respond to developer inputs in a way that mimics human communication.

In operation, a developer provides an input to the software development system 104. The input can be natural language text describing aspects of the software that the software developer wishes to generate using the software development system 104. Given the input, the component identification module 110 of the software development system 104 identifies one or more component specifications from the component specification datastore 120. The component identification module 110 can employ a number of different approaches for identifying relevant component specifications based on natural language text from inputs depending on the structure of the component specification datastore 120. For instance, in some aspects, a text-based approach is used that can involve using text from both the natural language input and the component specifications. This approach can employ techniques, such as keyword matching, TF-IDF, or reverse indexing. These techniques can rely on the presence and frequency of specific terms (e.g., tokens, n-grams, etc.) to identify relevant component specifications for a given input.

In some aspects, an embedding-based approach is used. In such configurations, a component specification embedding is generated for each component specification, and each component specification embedding is stored in the component specification datastore 120 (which can comprise a vector database that stores, indexes, and retrieves component specification embeddings). The component specification embeddings can be generated by an embedding model, which is a machine learning model (e.g., a neural network) that converts each component specification into a vector representation, where semantically similar pieces of the component specifications are mapped to vector representations that are close in a high-dimensional space. Examples of embedding models that could be employed include the Word2Vec model and more advanced models like BERT (Bidirectional Encoder Representations from Transformers) models. Given an input, the component identification module 110 generates an input embedding (e.g., using the embedding model) and searches the component specification datastore 120 to identify similar component specification embedding(s). Similarity of the embeddings can be determined using any of a number of different techniques, such as cosine similarity.

A variety of other approaches can be employed, such as: rule-based systems that use predefined rules to match natural language input to component specifications (e.g., given certain keywords or phrases in the input, specific rules trigger the selection of relevant specifications); ontology-based approaches that involve using a structured representation of knowledge (ontology) that leverages structured knowledge representations (ontologies) to enhance understanding, categorization, and retrieval of information; case-based reasoning that involves storing past cases (e.g., previous inputs and their matched components specifications) and using them to identify component specifications for new inputs; and machine learning approaches in which a machine learning model is trained to return component specifications based natural language input.

The above approaches for identifying relevant component specifications based on natural language inputs are provided by way of example only and not limitation, and other approaches can be employed. Additionally, the component identification module 110 can use any combination of approaches for identifying component specifications.

After one or more component specifications have been identified for an input by the component identification module 110, the prompt generation module 112 of the software development system 104 generates a prompt using the input and the component specification(s), and the prompt is provided to the generative model 114 for code generation. As used herein, a prompt can generally comprise any input to the generative model 114 that the generative model 114 processes to generate an output. The prompt generation module 112 can generate a prompt in a number of different manners. In some aspects, the prompt generation module 112 accesses a pre-defined prompt that instructs the generative model 114 to process the input and a context that comprises the component specification(s). In other aspects, the prompt generation module 112 accesses a prompt template and updates the prompt template based on the input and/or the component specification(s). In further aspects, the prompt generation module 112 employs a one-shot/few-shot approach in which the prompt includes one or more examples to help guide the generative model 114. For instance, a prompt could include an example of an output format.

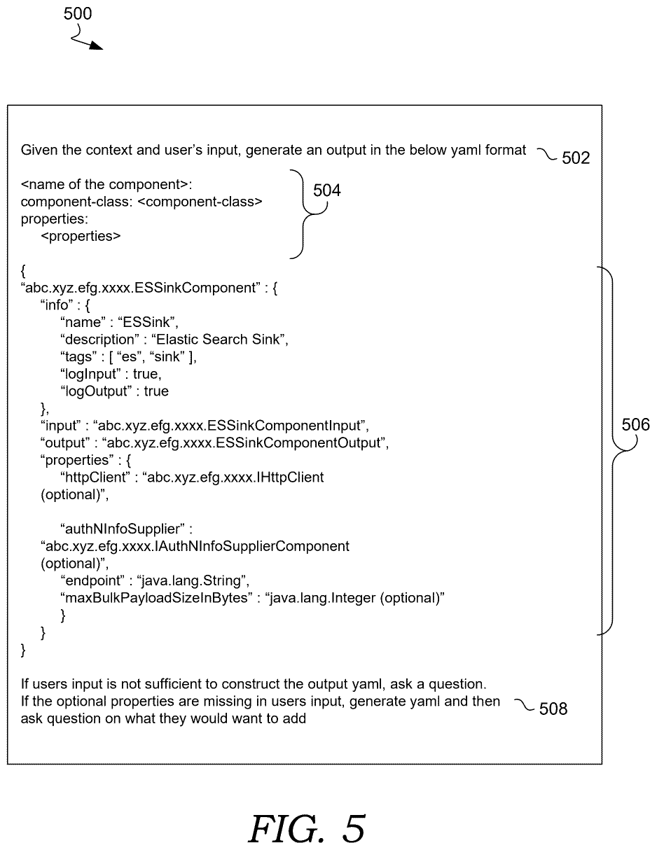

By way of illustration, FIG. 5 provides an example of a prompt 500. In this example, the prompt 500 includes pre-defined text 502 that instructs the generative model to use the user's input and a context 506 that comprises an identified component specification. The prompt 500 is also an example of using a one-shot approach as it includes an example 504 of an output format to use for a generated component instance. The prompt further includes text 508 instructing the generative model how to handle a situation in which the user input does not include sufficient information to generate an output or does not include information for an optional property.

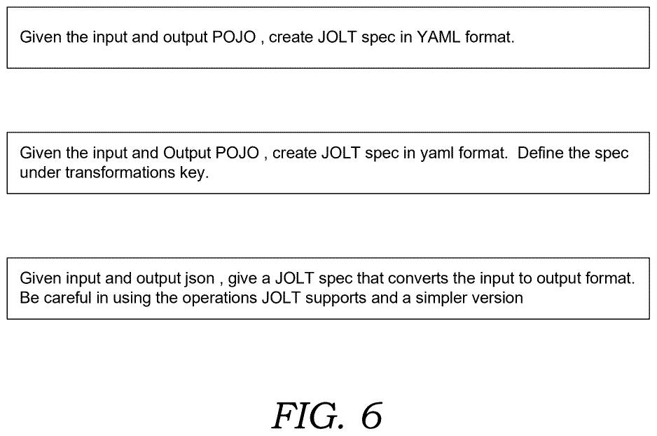

While FIG. 5 provides an example of a prompt for generating a single component instance, the prompt generation module 112 can generate prompts with a variety of different instructions, including instructions to: generate one or more component specifications, generate a control flow logic, and/or generate one or more translation layers between component instances. For instance, FIG. 6 provides examples of different prompts that can be used for translation layer generation. Instructions to generate component instance(s), control flow logic, and/or translation layer(s) can be included in a single prompt or in multiple prompts. In instances of back and forth interactions between a developer and the software development system 104, the prompt generation model 112 can generate different prompts at different points of the interaction, using a current developer input and/or previous developer inputs depending on the context.

The generative model 114 of the software generation system 104 processes a prompt to generate code. In particular, the generative model generates component instance(s) by hydrating one or more properties of component specification(s) identified for an input with data elements from the input. For instance, the generative model 114 can perform NLP operations on the natural language text in the input to identify data elements as corresponding to certain properties in the identified component specifications in order to generate component instances by adding the data elements to the corresponding properties in the component specifications.

In some instances, only a single component specification is identified for an input, and the generative model 114 hydrates that component specification based on the input to provide a single component instance. In other instances, multiple component specifications are identified for an input, and the generative model 114 hydrates each component specification based on the input to provide multiple component instances. The generative model 114 also determines a control flow logic specifying an order in which the component instances are executed and how data flows between component instances. In order to connect component instances based on the control flow logic, the generative model 114 also generates translation layers between successive component instances. In particular, for each connection, the generative model 114 generates a translation layer that translates the output from one component instance to the input to a second component instance. As such, the generated translation layers connect the outputs of component instances to the inputs of subsequent component instances in the control flow logic.

The generative model 114 can comprise a language model that includes a set of statistical or probabilistic functions to perform NLP in order to understand, learn, and/or generate human natural language text and code. For example, a language model can be a tool that determines the probability of a given sequence of words occurring in a sentence, natural language sequence, and/or code. A language model is called a large language model (LLM) when it is trained on enormous amount of data and/or has a large number of parameters. Some examples of LLMs are GOOGLE's BERT and OpenAI's GPT-4. These models have capabilities ranging from writing a simple essay to generating complex computer codes - all with limited to no supervision. Accordingly, an LLM can comprise a deep neural network that is very large (e.g., billions to hundreds of billions of parameters) and understands, processes, and produces human natural language and code by being trained on massive amounts of text. These models can predict future words in a sequence letting them, for instance, generate sentences similar to how humans talk and write or otherwise in a form dictated, for instance, by a prompt.

In accordance with some aspects, the generative model 114 comprises a neural network. As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In some configurations, the generative model 114 is a pre-trained model (e.g., GPT-4, Llama 2, etc.) that has not been fined-tuned. In other configurations, the generative model 114 is a model that is built and trained from scratch or a pre-trained model that has been fine-tuned. In such configurations, the generative model can be trained or fine-tuned using training data. For instance, the training data could comprise training samples, where each training sample comprises one or more component specifications, natural language text, and ground truth code (e.g., component instance(s) and/or translation layer(s)). During training, weights associated with each neuron can be updated. Originally, the generative model can comprise random weight values or pre-trained weight values that are adjusted during training. In one aspect, the generative model is trained using backpropagation. The backpropagation process comprises a forward pass, a loss function, a backward pass, and a weight update. For instance, a forward pass could comprise providing component specifications and natural language text from a training sample as input to the generative model 114, which outputs code comprising component instances and translation layers. A loss could then be determined based on a comparison of the output code and the ground truth code from the training sample, and weights of the generative model are updated based on the loss. This process is repeated using the training data. The goal is to update the weights of each neuron (or other model component) to cause the generative model to produce useful output when given prompts. Once trained, the weight associated with a given neuron can remain fixed. The other data passing between neurons can change in response to a given input. Retraining the network with additional training data can update one or more weights in one or more neurons.

Code generated by the software development system 104 can be stored in a code repository 122. The code repository 122 can comprise, for instance, a centralized storage location where developers keep, manage, and track their code and related files. In some aspects, the code repository 122 enables version control, allowing multiple developers to collaborate on a project by tracking changes, managing different versions of the code, and merging updates from different contributors. Examples of version control systems for code repositories include Git (used with platforms like GitHub, GitLab, and Bitbucket), Subversion (SVN), and Mercurial. The code repository 122 can help maintain a complete history of code changes, making it easier to roll back to previous versions and ensure collaboration across development teams.

As previously indicated, in some instances, component specifications can be created from legacy code. This is performed in the software development system 104 by the code normalization module 116. The code normalization module 116 employs normalization rules that ensure the component specifications created from legacy code conform to a specific schema. The following discussion provides example rules that can be used by the code normalization module 116. The examples provide normal forms that involve extracting data and logic at various levels of abstraction to conform with the component specification schema while also maximizing customization. In these examples, all higher order forms meet the prior order criteria.

First Normal form (1NF): This form is the minimum expectation to be qualified as a component and specification following a standard component specification schema. A (degenerate) example would be a component that takes in no instantiation parameters, null input, and produces null output. Side-effects can be produced as secondary output.

Second Normal Form (2NF): In this form, instantiation parameters are explicitly defined and specified. These can include a range of data hard-coded into the logic, i.e., any type of constant (string, numeral, et al). An equivalent in the functional programming world would be the reader monad.

Third Normal Form (3NF): This form evolves the component into a “pure function” honoring referential integrity seen in functional programming paradigms. Input, output, and instantiation parameters are explicitly defined and specified. This form parametrizes all static and dynamic data that will be used in the component execution.

Fourth Normal Form (4NF): This form is inspired by the “strategy” design pattern, the corresponding equivalent of “higher order” functions in the functional programming world. In-addition to data parameterization, this form involves logic (aka strategy) being parameterized into the system in instantiation, input, or output.

Fifth Normal Form (5NF): This form is the highest order of canonical representation of a component in which execution code is assembled on the fly with instantiation parameters and input, and output similarly being non-decomposable beyond the outputted form. An extreme example would be an orchestrator component, orchestration script, along with other parameters necessary for instantiation, and inputs.

Application of the normal forms: Beyond advocating better coding practices and a structure to reason about, AI-based coding agents can adhere to the normal forms to generate or refactor code. This generation by itself will help the generative AI to hydrate the parameters in the normal form.

The software development system 104 further includes a user interface module 118 that provides one or more user interfaces for interacting with the software development system 104. The user interface module 118 provides one or more user interfaces to a developer device, such as the developer device 102. In some instances, the user interfaces can be presented on the developer device 102 via the application 108, which can be a web browser or a dedicated application for interacting with the software development system 104. Among other things, the user interface module 118 provides user interfaces for interacting with the software development system 104 to develop software in an interactive fashion. In some aspects, the user interface module 118 provides a chat interface that allows interaction between a developer and the software development system 104 using natural language.

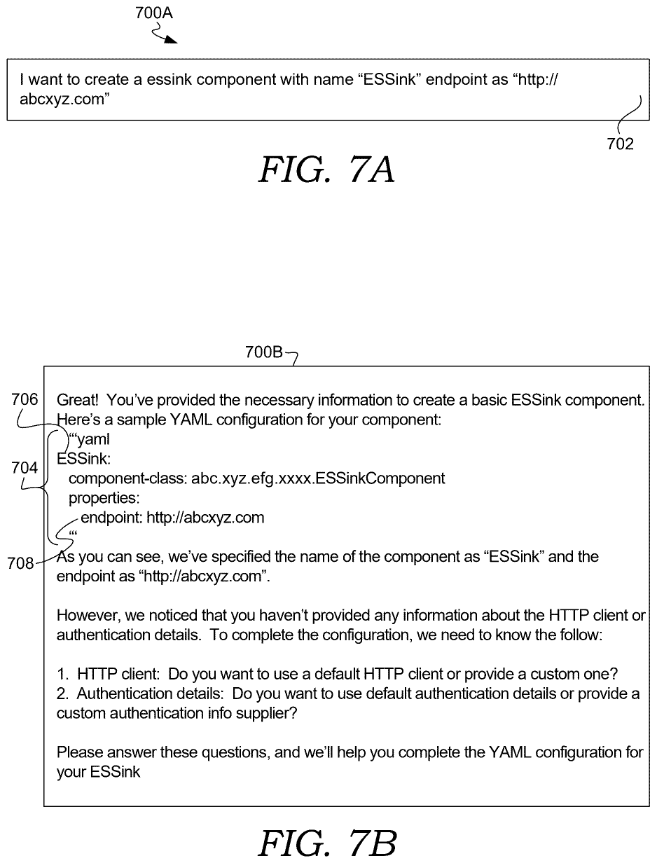

By way of illustration, FIGS. 7A and 7B provide example user interfaces for generating a component instance. In particular, FIG. 7A provides an example user interface 700A for entering a natural language input. In this example, a developer has entered the natural language text 702:“I want to create a essink component with name ‘ESSink’ endpoint as ‘http://estress.com.’” In response to this input, the system provides the user interface 700B shown in FIG. 7B. In this example, the system has identified a component specification based on the input provided in FIG. 7A. The component specification, could be, for instance, the example Elastic search component specification shown in FIG. 4A. The system has hydrated the component specification based on the title and endpoint specified in the input to generate a component instance in YAML, and the user interface 700B presents the component instance 704 with a title 706 and endpoint 708 based on the input. Because the component specification includes other properties that have not been hydrated based on the input, including an HTTP client property and authentication property, the user interface 700B also asks the developer if they would like to use a default for each of if they would prefer to use custom ones. The developer can then provide another input either specifying to use the default for the properties or providing data for custom ones. Based on that input, the system would generate the completed component instance (e.g., in YAML or another language).

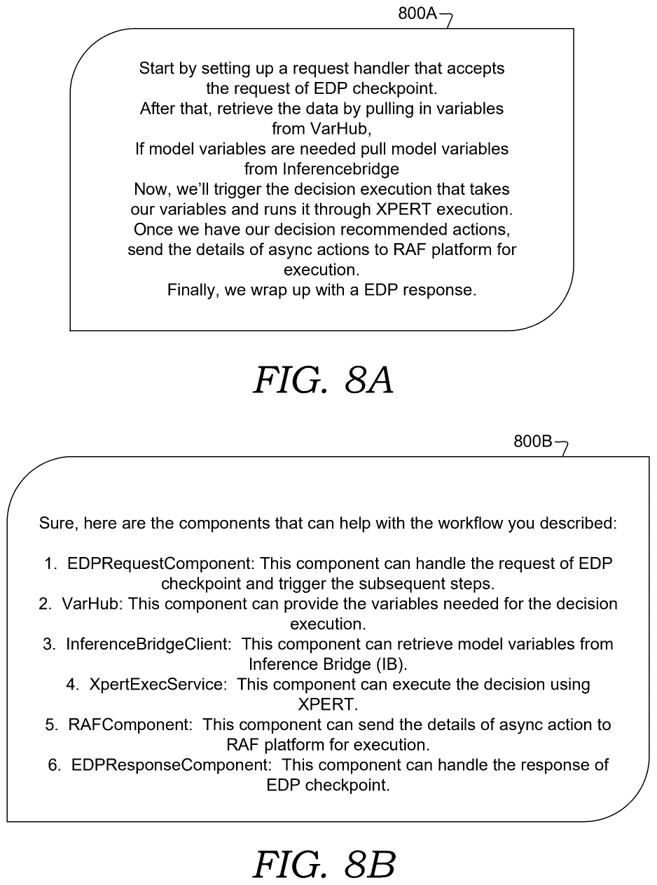

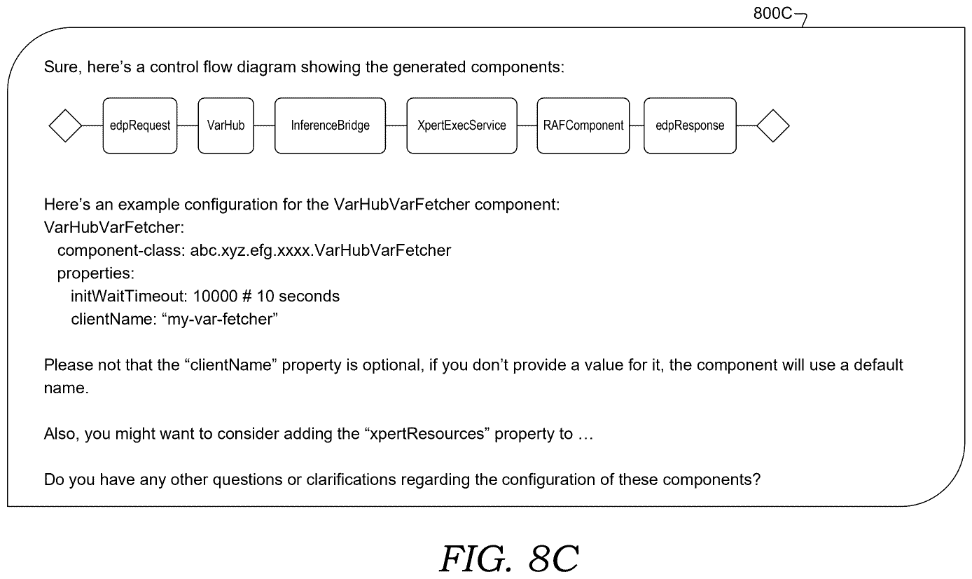

FIGS. 8A-8C provide another series of example user interfaces in which multiple component instances with translation layers are generated. In particular, FIG. 8A provides an example user interface 800A for entering a natural language input. In this example, a developer has entered the natural language text: “Start by setting up a request handler that accepts the request of EDP checkpoint. After that, retrieve the data by pulling in variables from VarHub, If model variables are needed pull model variables from Inferencebridge Now, we'll trigger the decision execution that takes our variables and runs it through XPERT execution. Once we have our decision recommended actions, send the details of async actions to RAF platform for execution. Finally, we wrap up with a EDP response.” In response to this input, the system provides the user interface 800B shown in FIG. 8B. In this example, the system has identified a number of component specifications based on the input provided in FIG. 8A and presented the identified component specifications in the user interface 800B. In particular, the system has identified the following component specifications: EDPRequestComponent; VarHub; InferenceBridgeClient; XpertExecService; RAFComponent; and EDPResponseComponent.” In some aspects, this allows the developer to review the selected component specifications and determine if any modifications are needed. For instance, the developer could provide an input approving the use of those component specifications, or provide an input instructing the system to modify which component specifications are to be used.

FIG. 8C provides a user interface 800C, providing information regarding the code output from the generative model using the natural language text entered in the user interface 800A and the component specifications identified in the user interface 800B. The user interface 800C includes additional suggestions and requests for data to further populate properties of certain components. In the case of an optional property, the user interface 800C can indicate a default that will be used if data is not provided for the property. In the case of a required property, the user interface 800C can indicate the property and request the developer provide data for that property.

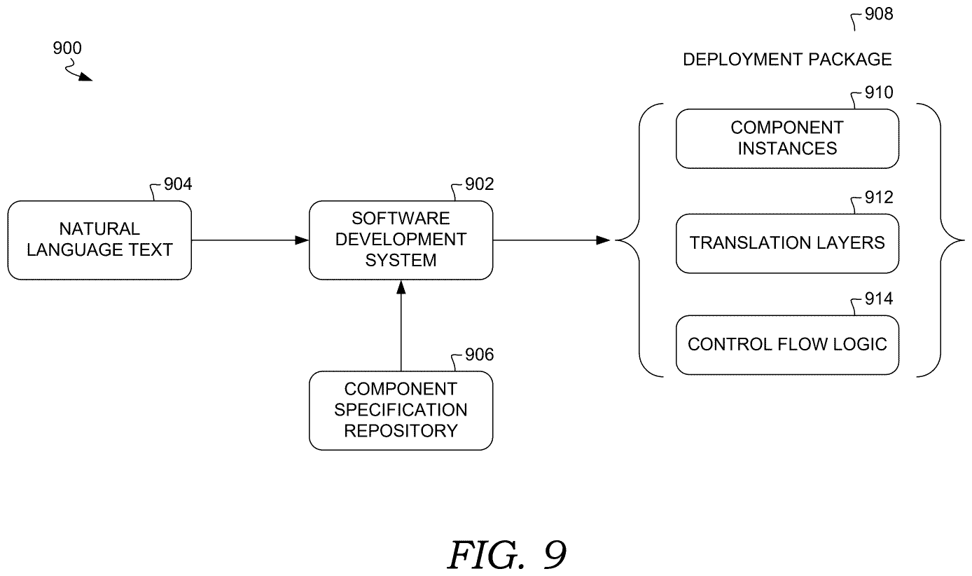

Turning next to FIG. 9, a block diagram is provided illustrating an example process 900 for code development using some aspects of the technology described herein. As shown in FIG. 9, a software development system 902 receives natural language text 904 as an initial input (e.g., from a developer). Based on the natural language text 904, the software development system 902 identifies relevant component specifications from a component specification repository 906. Using the identified component specifications and the natural language text 904, the software development system 902 outputs a deployment package 908, which includes component instances 910, translation layers 912, and a control flow logic 914. A generative model of the software development system 902 generates the component instances 910 by hydrating properties of the identified component specifications using aspects specified in the natural language text 904. The generative model also determines the control flow logic 914 (including the order of execution of the component instances 910) using the natural language text, and generates the translation layers 912 in order to connect outputs to inputs of successive component instances.

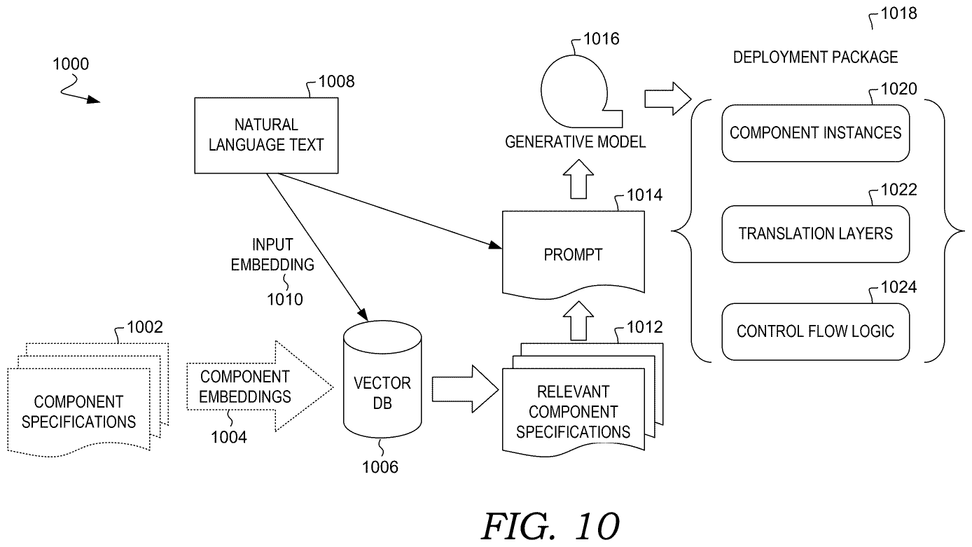

FIG. 10 provides a block diagram showing another example process 1000 for code development using some aspects of the technology described herein. As shown in FIG. 10, component specifications 1002 for the system are embedded into component specification embeddings 1004 and stored in a vector database 1006. The vector database 1006 can be a specialized database designed to store, index, and query embeddings. The vector database 1006 enables efficient similarity searches, such as nearest neighbor queries, to find embeddings that are close in the embedding space.

When natural language text 1008 is received as an input, the natural language text 1008 is embedded into an input embedding 1010. A similarity search is performed on the vector database 1006 to identify component specification embeddings that are similar to the input embedding 1010. For instance, a nearest neighbor search could be performed using cosine similarity to determine similarity between the input embedding 1010 and component specification embeddings in the vector database 1006.

The similarity search on the vector database 1006 provides a set of relevant component specifications 1012. A prompt 1014 is generated using the relevant component specifications 1012 and the natural language text 1008. The prompt 1014 can include text for instructing a generative model 1016 how to generate code using the relevant component specifications 1012 and the natural language text 1008. In some aspects, the prompt 1014 employs a one-shot/few-shot approach in which one or more examples are provided in the prompt 1014 to help guide the generative model 1016.

Based on the prompt, the generative model 1016 outputs a deployment package 1018, which includes component instances 1020, translation layers 1022, and a control flow logic 1024. The generative model 1016 generates the component instances 1020 by hydrating properties of the relevant component specifications 1012 using aspects specified in the natural language text 1008. The generative model 1016 also determines the control flow logic 1024, including the order of execution of the component instances 1020, using the natural language text, and generates the translation layers 1022 in order to connect outputs to inputs of successive component instances.

### Example Methods for Code Generation Using Component Ecosystem and Generative AI

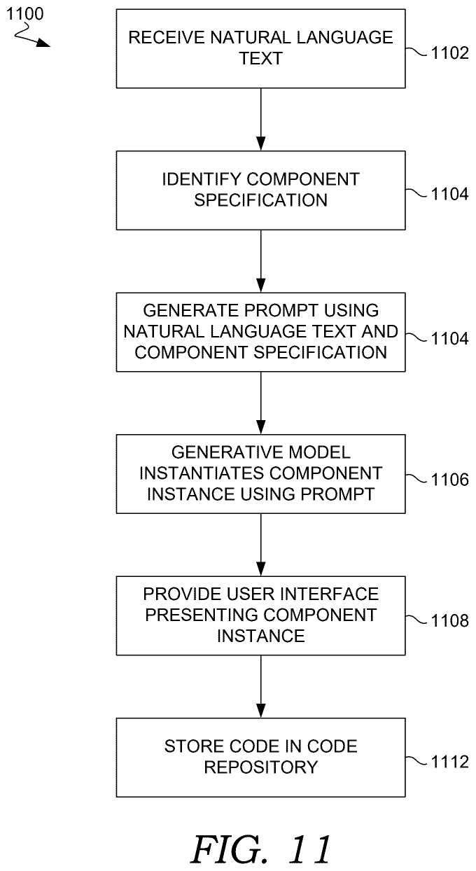

With reference now to FIG. 11, a flow diagram is provided that illustrates a method 1000 for instantiating a component instance using a component ecosystem and generative AI. The method 1100 can be performed, for instance, by the software development system 104 of FIG. 1. Each block of the method 1100 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 1102, natural language text is received. For instance, a developer can provide input comprising natural language text describing code to be generated by the system. Based on the natural language text, a component specification is identified from a component specification datastore, as shown at block 1104. The component specification datastore provides a repository of component specifications. Each component specification sets forth an input, an output, and a set of one or more properties. In some instances, each component specification also has a corresponding textual description. The component specification can be identified at block 1104 using a variety of different approaches, such as text-based approaches, embedding-based approaches, rule-based approaches; ontology-based approaches; case-based reasoning; and machine learning approaches, to name a few.

As shown at block 1106, a prompt is generated using the natural language text and the component specification identified at block 1104. The prompt can be generated, for instance, using a pre-defined prompt, a prompt template, and/or one-shot/few-shot approaches, as well as other techniques. The prompt is provided to a generative model at block 1108, causing the generative model to instantiate a component instance by hydrating at least one property of the component specification based on the natural language text. The generative model identifies relevant data from the natural language text to hydrate one or more properties in the component specification to provide the component instance.

A user interface is provided that presents the component instance, as shown at block 1110. In some aspects, the user interface requests additional information, such as in cases in which data for a property of the component specification has not been provided. The code for the component instance is stored in a code repository (e.g., the code repository 122 of FIG. 1), as shown at block 1112.

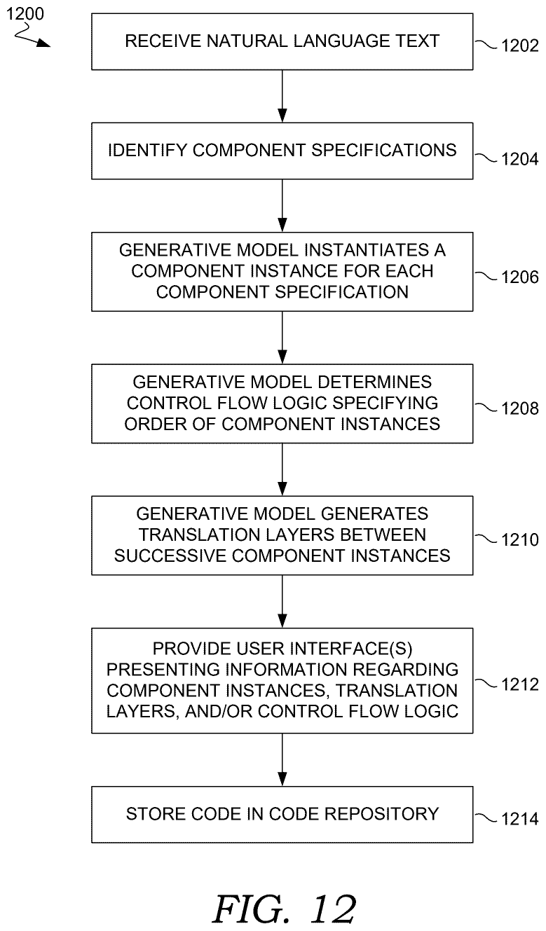

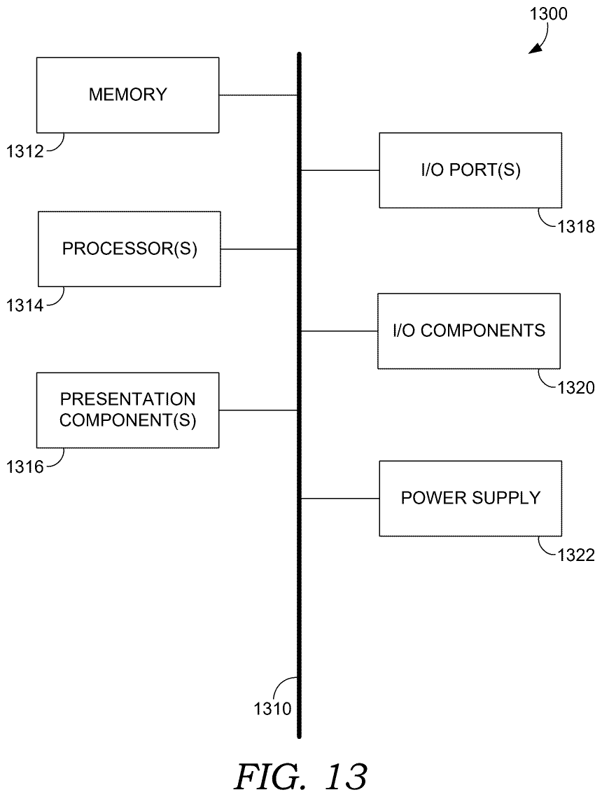

Turning next to FIG. 12, a flow diagram is provided that shows a method 1200 for generating code with multiple components connected by translation layers using a component ecosystem and generative AI. The method 1200 can be performed, for instance, by the software development system 104 of FIG. 1.

As shown at block 1202, natural language text is received. For instance, a developer can provide input comprising natural language text describing code to be generated by the system. Based on the natural language text, multiple component specifications are identified from a component specification datastore, as shown at block 1204. The component specification datastore provides a repository of component specifications. Each component specification sets forth an input, an output, and a set of one or more properties. In some instances, each component specification also has a corresponding textual description. The component specifications can be identified at block 1204 using a variety of different approaches, such as text-based approaches, embedding-based approaches, rule-based approaches; ontology-based approaches; case-based reasoning; and machine learning approaches, to name a few.

As shown at block 1206, a generative model instantiates a component instance for each component specification identified at block 1204 by hydrating properties of the component specifications based on the natural language text. The generative model identifies relevant data from the natural language text to hydrate the properties in the component specifications to provide the component instances. The generative model also determines a control flow logic specifying an order of the component instances, as shown at block 1208. Based on the control flow logic, the generative model generates translation layers between successive component instances, as shown at block 1210. Each translation layer is generated to translate the output from a component instance to an input for a subsequent component instance.

A user interface is provided that presents information regarding the component instances, the translation layers, and/or the control flow logic, as shown at block 1212. In some aspects, the user interface requests additional information, such as in cases in which data for a property of the component specification has not been provided. Once any additional iterations have been completed, the code for the component instances, translation layers, and control flow logic is stored in a code repository (e.g., the code repository 122 of FIG. 1), as shown at block 1214.

### Exemplary Operating Environment

Having described implementations of the present disclosure, an exemplary operating environment in which embodiments of the present technology can be implemented is described below in order to provide a general context for various aspects of the present disclosure. Referring initially to FIG. 13 in particular, an exemplary operating environment for implementing embodiments of the present technology is shown and designated generally as computing device 1300. Computing device 1300 is but one example of a suitable computing environment and is not intended to suggest any limitation as to the scope of use or functionality of the technology. Neither should the computing device 1300 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 13, computing device 1300 includes bus 1310 that directly or indirectly couples the following devices: memory 1312, one or more processors 1314, one or more presentation components 1316, input/output (I/O) ports 1318, input/output components 1320, and illustrative power supply 1322. Bus 1310 represents what can be one or more busses (such as an address bus, data bus, or combination thereof). Although the various blocks of FIG. 13 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 13 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 13 and reference to “computing device.”

Computing device 1300 typically includes a variety of computer-readable media. Computer-readable media can be any available media that can be accessed by computing device 1300 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1300. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1312 includes computer storage media in the form of volatile and/or nonvolatile memory. The memory can be removable, non-removable, or a combination thereof. Exemplary hardware devices include solid-state memory, hard drives, optical-disc drives, etc. Computing device 1300 includes one or more processors that read data from various entities such as memory 1312 or I/O components 1320. Presentation component(s) 1316 present data indications to a user or other device. Exemplary presentation components include a display device, speaker, printing component, vibrating component, etc.

I/O ports 1318 allow computing device 1300 to be logically coupled to other devices including I/O components 1320, some of which can be built in. Illustrative components include a microphone, joystick, game pad, satellite dish, scanner, printer, wireless device, etc. The I/O components 1320 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 1300. The computing device 1300 can be equipped with depth cameras, such as, stereoscopic camera systems, infrared camera systems, RGB camera systems, and combinations of these for gesture detection and recognition. Additionally, the computing device 1300 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
receiving natural language text;
accessing, from a component specification datastore storing a plurality of component specifications, a first component specification based on the natural language text, the first component specification comprising a first input, a first output, and a first set of one or more properties;
generating a prompt using the natural language text and the first component specification; and
causing a generative model to use the prompt to instantiate a first component instance by hydrating at least one property of the first set of one or more properties based on the natural language text.

2. The one or more computer storage media of claim 1, wherein the first component specification comprises a textual description of the first component specification, and wherein the first component specification is determined for the natural language text using the textual description.

3. The one or more computer storage media of claim 1, wherein the component specification datastore stores a component specification embedding for each of the plurality of component specifications, and wherein accessing the first component specification comprises:
generating an input embedding of at least a portion of the natural language
text; and
identifying the first component specification based on a comparison of the input embedding and a first component embedding for the first component specification. The one or more computer storage media of claim 1, wherein the operations further comprise:
accessing, from the component specification datastore, a second component specification based on the natural language text, the second component specification comprising a second input, a second output, and a second set of one or more properties; and
causing the generative model to instantiate a second component instance by hydrating at least one property of the second set of one or more properties based on the natural language text.

5. The one or more computer storage media of claim 4, wherein the operations further comprise:
causing the generative model to generate a control flow logic specifying an order of the first component instance and the second component instance.

6. The one or more computer-storage media of claim 4, wherein the operations further comprise:
causing the generative model to generate a translation layer between the first component instance and the second component instance based on the first output and the second input.

7. The one or more computer storage media of claim 1, wherein the first component specification is generated by normalizing a legacy code to provide the first input, the first output, and the first set of one or more properties.

8. The one or more computer storage media of claim 1, wherein the operations further comprise, prior to causing the generative model to use the prompt to instantiate the first component instance:
providing a user interface presenting the first component specification; and
receiving user input selecting the first component specification.

9. The one or more computer storage media of claim 1, wherein the operations further comprise:
providing a user interface presenting the first component instance;
receiving additional user input; and
causing the generative model to update the first component instance using the additional user input.

10. A computer-implemented method comprising:
receiving natural language text;
accessing, from a component specification datastore storing a plurality of component specifications, two or more component specifications based on the natural language text, each of the two or more component specifications comprising a corresponding input, a corresponding output, and one or more corresponding properties;
instantiating, by a generative model, two or more component instances using the two or more component specifications, each component instance of the two or more component instances being instantiated by hydrating at least one corresponding property of the one or more corresponding properties for each component instance based on the natural language text;
determining, by the generative model, a control flow logic specifying an order of the two or more component instances; and
generating, by the generative model, one or more translation layers between at least a portion of the two or more component instances based on the order specified by the control flow logic.

11. The computer-implemented method of claim 10, wherein each component specification from the two or more component specifications comprises a corresponding textual description, and wherein the two or more component specifications are determined for the natural language text using the corresponding textual descriptions.

12. The computer-implemented method of claim 10, wherein the component specification datastore stores a corresponding component specification embedding for each of the plurality of component specifications, and wherein accessing the two or more component specifications comprises:
generating an input embedding of at least a portion of the natural language text; and
identifying the two or more component specifications based on a comparison of the input embedding and the corresponding component embeddings for the two or more component specifications.

13. The computer-implemented method of claim 12, wherein the method further comprises, prior to instantiating the two or more component instances using the two or more component specifications:
providing a user interface presenting the two or more component specifications; and
receiving user input selecting the two or more component specifications.

14. The computer-implemented method of claim 10, wherein the method further comprises:
providing a user interface presenting the two or more component instances, the control flow logic, and/or the one or more translation layers;
receiving additional input; and
updating, by the generative model using the additional input, one or more selected from the following: a selected component instance from the two or more component instances, the control flow logic, and a selected translation layer from the one or more translation layers.

15. The computer-implemented method of claim 10, wherein a first component specification of the two or more component specifications is generated by normalizing a legacy code to provide the corresponding input, the corresponding output, and the one or more corresponding properties for the first component specification.

16. A computer system comprising:
a processor; and
a computer storage medium storing computer-useable instructions that, when used by the processor, causes the computer system to perform operations comprising:
generating an input embedding from a natural language text;
identifying, from a component specification datastore storing a plurality of component specification embeddings, a first component specification and a second component specification based on the input embedding, the first component specification comprising a first input, a first output, and a first set of one or more properties, the second component specification comprising a second input, a second output, and a second set of one or more properties;
generating a prompt using the natural language text, the first component specification, and the second component specification; and
causing a generative model to use the prompt to instantiate a first component instance from the first component specification and a second component instance from the second component specification by hydrating at least one property of the first set of one or more properties and the second set of one or more properties based on the natural language text; and
causing the generative model to generate a translation layer between the first component instance and the second component instance using the first output and the second input.

17. The computer system of claim 16, wherein the operations further comprise, prior to instantiating the first component instance and the second component instance:
providing a user interface presenting the first component specification and the second component specification; and
receiving user input selecting the first component specification and the second component specification.

18. The computer system of claim 16, wherein the operations further comprise:
providing a user interface presenting the first component instance, the second component instance, and/or the translation layer;
receiving additional input; and
updating, by the generative model using the additional input, the first component instance, the second component instance, and/or the translation layer.

19. The computer system of claim 16, wherein the operations further comprise:
determining, by the generative model, a control flow logic specifying an order of the first component instance and the second component instance.

20. The computer system of claim 16, wherein the first component specification is generated by normalizing a legacy code to provide the first input, the first output, and the first set of one or more properties.
